(19) United States
(12) Patent Application Publication
(10) Pub. No.: US 2016/0267822 A1
(43) Pub. Date: Sep. 15, 2016

(54) APPARATUS FOR CREATING A COMPOSITE IMAGE

(71) Applicant: CHARLES R. FENDER, The Villages, FL (US)

(72) Inventor: CHARLES R. FENDER, The Villages, FL (US)

(21) Appl. No.: 14/643,407

(22) Filed: Mar. 10, 2015

(51) Int. Cl. G09F 9/46

(52) U.S. Cl. CPC G09F 9/46

(57) ABSTRACT

Apparatus for aligning a plurality of partial images from time to time to form a composite image, including a motor having two or more concentric rotating output shafts rotating at different speeds. Each of the partial images is supported by one of the shafts. As a function of the relative rates of rotation of the shafts, all of the partial images become aligned from time to time to form the composite image.

### BACKGROUND OF THE INVENTION

1. Field of the Invention

The present invention relates to rotating images and, more particularly, to form from time to time a composite image from two or more partial images.

2. Description of Related Prior Art

Sports fans are often avid collectors of sports memorabilia in the form of posters, pins, decals, hats, etc. depicting a sports team logo. Very often an image cherished by a sports fan is that of a player, a team or even a park setting wherein the pertinent game is played. Similarly, corporations advertise their goods or services through a medium of a logo. In the field of entertainment, images of cartoon characters, actors, actresses, musicians, bands, etc. are depicted on posters or the like and cherished. In the field of politics, images of candidates or aspiring politicians are depicted on posters, cards, and other surfaces to promote a candidate or a particular political party. A list of images cherished or lauded by segments of the population is endless as it includes all aspects of human interests.

One of the difficulties or drawbacks of presently available images is that they are static. That is, except for rare occasions, these images are immobile and do nothing to draw attention to them other than the subject matter depicted. After a period of viewing, these images generally become boring. This is true even for avid collectors of images and persons who view these images for inspiration or adoration.

### SUMMARY OF THE INVENTION

The present invention is directed to two partial images, when aligned with one another, form a composite image. The subject matter of such composite image may be a depiction of any subject. Each partial image is attached to one of a plurality of concentric shafts. A motive means, such as an electric motor, rotates each shaft at a different speed. As a result, one of the partial images will become aligned with the other partial image at each rotation in excess of 360° and depict the composite image. For greater complexity, three or more partial images may be mounted on concentric shafts wherein each shaft rotates at a different speed. As a function of the respective rates of rotation, these three or more partial images will become aligned from time to time to display a composite image.

It is therefore a primary object of the present invention to provide mobile partial images rotating about a common axis to display a composite image from time to time.

Another object of the present invention is to provide a first rotating partial image and a second rotating partial image rotating about a common axis to display a composite image from time to time.

Yet another object of the present invention is to provide a first rotating partial image and a second rotating partial image to form a composite image as a function of the respective rates of rotation of the first and second partial images.

Still another object of the present invention is to provide motive means for rotating first and second partial images at different rotation rates to form and reform a composite image.

A further object of the present invention is to provide an amusing display of partial images rotating about a common axis that form a composite image from time to time.

A yet further object of the present invention is to provide a method for a pair of discs rotating about a common axis with each disc displaying a partial image to form a composite image from time to time.

A still further another object of the present invention is to provide a mobile device for repetitively aligning a partial image with a fixed partial image to display a composite image.

These and other objects of the present invention will become apparent to those skilled in the art as the description thereof proceeds.

### BRIEF DESCRIPTION OF THE DRAWINGS

The present invention will be described with greater specificity and clarity with reference to the following drawings, in which:

FIG. 1 illustrates a composite image that is formed by two or more partial images;

FIG. 2 illustrates a first partial image of the composite image illustrated in FIG. 1;

FIG. 3 illustrates a second partial image of the composite image illustrated in FIG. 1;

FIG. 4 illustrates superimposition of the partial images illustrated in FIGS. 2 and 3 when not aligned with one another;

FIG. 5 illustrates a three-quarter view of two partial images on respective discs supported by concentric shafts rotating at different rates of rotation;

FIG. 6 illustrates a side view of two partial images mounted upon two motor driven concentric shafts;

FIG. 7 illustrates a mounting containing two or more displays, each formed by rotating partial images;

FIG. 8 illustrates a representative football player depicted as a composite image formed by two or more partial images;

FIG. 9 illustrates three partial images mounted on respective discs supported by respective concentric shafts rotating at different rates, of rotation;

FIG. 10 is a side view of the three discs supporting the three partial images depicted in FIG. 9 and mounted upon three concentric shafts rotating at different rates of rotation;

FIG. 11 illustrates the composite image formed periodically by the three partial images shown in FIGS. 9 and 10;

FIGS. 12, 13 and 14 illustrate the three partial images shown in FIG. 9 periodically forming the composite image illustrated in FIG. 11.

### DESCRIPTION OF THE PREFERRED EMBODIMENT

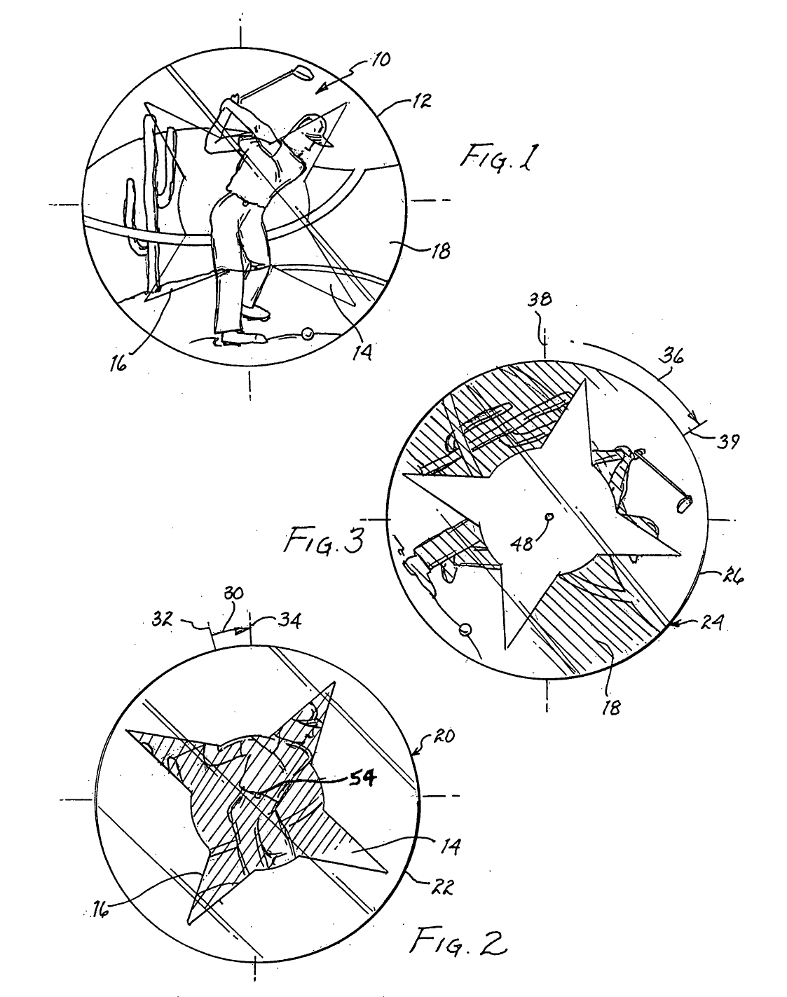

Referring to FIG. 1, there is illustrated a composite image 10 of a golfer on a desert golf course mounted on two superimposed discs collectively identified by numeral 12. The composite image is formed by a first partial image 14 having a star shaped outline 16. A second partial image 18 extends about outline 16 to the perimeter of disc 12. FIG. 2 illustrates a disc 20 supporting first partial image 14 located inwardly of perimeter 22 of disc 20. The area lateral of the first partial image to the perimeter of the disc is transparent. As illustrated, the first partial image depicts a part of the golfer and a part of the background. FIG. 3 illustrates the second partial image mounted on disc 24. It depicts a part of the golfer and a part of the background. As shown, the partial image extends to perimeter 26. The area inwardly of the second partial image is transparent.

Discs 20 and 24 are of transparent material, such as clear plastic, glass, etc. in the areas not containing the first or the second partial images, as set forth above. Arrow 30 at perimeter 22 extends between radial lines 32 and 34 depicted at the perimeter of disc 20 and represents a relative rate of rotation. Similarly, arrow 36 at perimeter 26 of disc 24 extends between radial lines 38, 39 to depict a relative rate of rotation compared to arrow 30. By comparing the length of arrows 30 and 36, it is evident that disc 20 rotates at a lesser rate of rotation than the rate of rotation of disc 24.

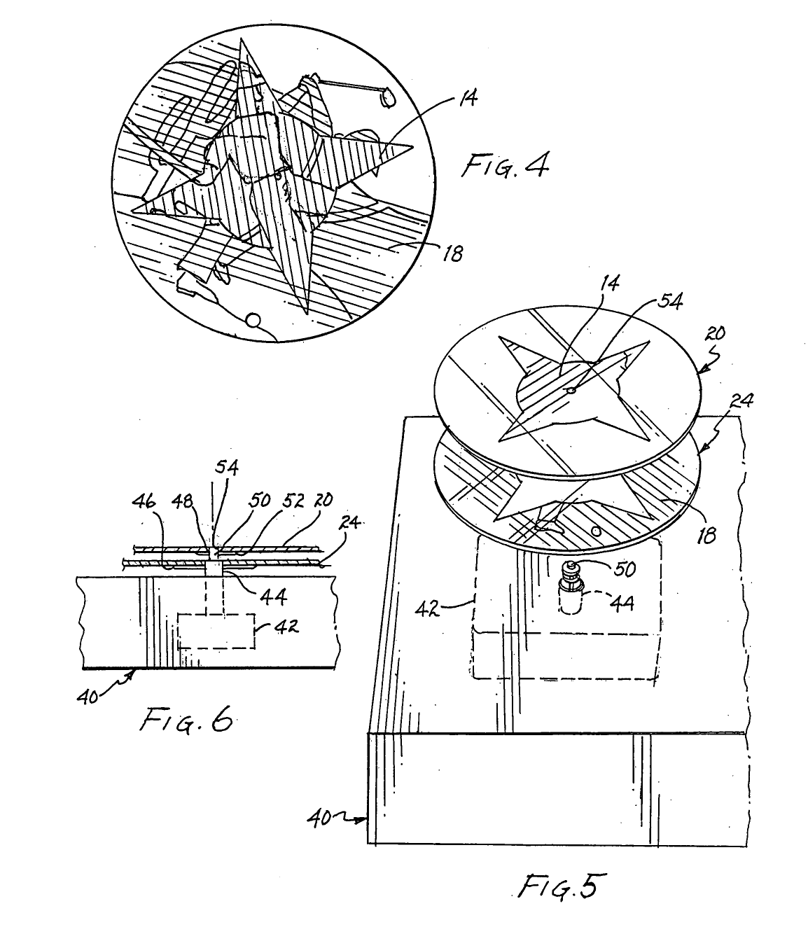

FIG. 4 depicts discs 20 and 24 mounted on a common axis of rotation. First partial image 14 and second partial image 18 are not aligned with one another to depict the composite image illustrated in FIG. 1. Variations of such superimposed partial images in non-alignment with one another will be present until such time as the first and second partial images come into registration to form the composite image shown in FIG. 1. That is, until registration occurs, the partial images will be a hodgepodge.

FIG. 5 illustrates a box, container, support or the like (40), for mounting motive means, such as an electric motor 42. The motor provides two concentric rotating shafts 44, 46 that rotate at different rates of rotation. As also shown in FIG. 6, shaft 44 may includes a roundel 45 to aid in supporting disc 24. The disc includes a central aperture 48 for penetrable engagement by and attachment to shaft 44. A mastic or adhesive of some type may be used to rigidly support disc 24 upon roundel 45 to ensure rotation of disc 24 commensurate with that of shaft 44. A rotating shaft 50, concentric with shaft 44, includes a roundel 52. Disc 20 includes an aperture 54 for penetrable engagement with shaft 50. A mastic or adhesive of some type may be used to secure disc 20 to roundel 52 to ensure rotation of the disc commensurate with the supporting shaft.

As pointed out above by the relative length of arrows 30 and 36, disc 20 rotates at a lesser rate of rotation than disc 24. However, at some point these discs will become aligned or superimposed whereby the first and second partial images form the composite image illustrated in FIG. 1. In particular, from time to time the partial image on rotating disc 24 will become aligned with the partial image depicted on rotating disc 20 and the composite image is momentarily created. It is to be understood that the relative rates of rotation of the discs may be at any speed.

In the alternative, shaft 44 could be fixed, or non-rotating to support disc 24 in a static non-rotating configuration. Upon rotation of shaft 50, the partial image on disc 20 would become aligned with disc 24 to display the composite image. This configuration could be quite interesting to watch the composite image being formed and unformed.

Referring to FIG. 7, there is illustrated a display case 60 containing two or more composite image generating devices 62 and 64 of the type discussed above and illustrated in FIGS. 1-6. The images depicted therein would normally be different and may be of sports memorabilia, cartoon characters, etc. The location of such display case may be at a place of business, such as a bar, a man cave, a gaming room in a residence, etc.

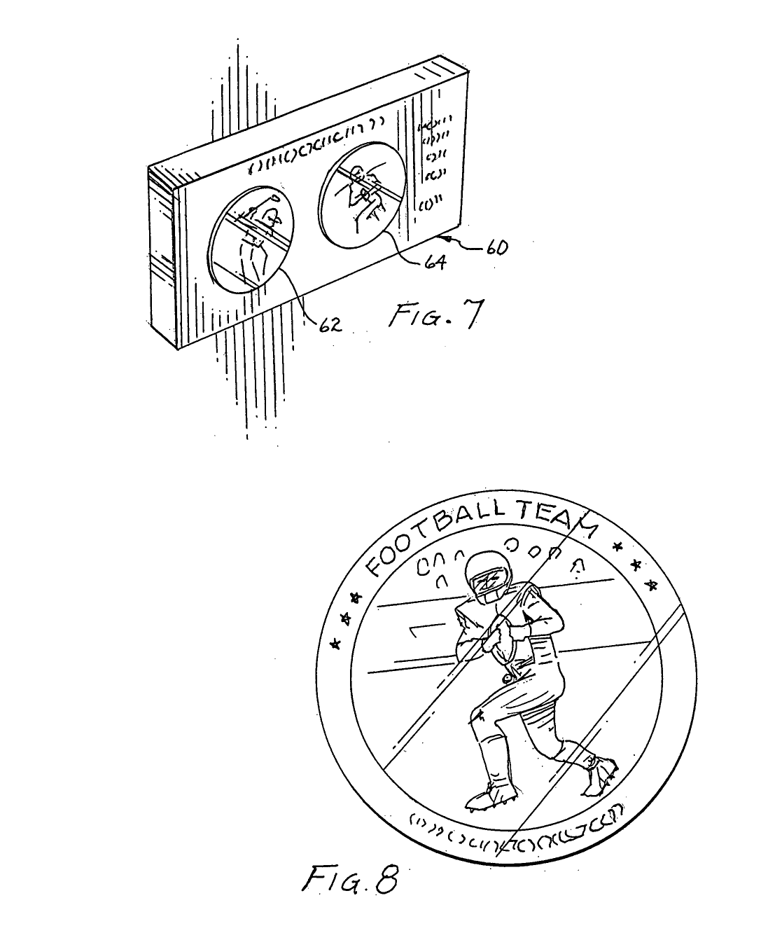

FIG. 8 illustrates a composite image of two or more partial images mounted on two or more discs and depicts a running football player carrying a ball. The depiction may include the name of a football team, and other writings that may be of interest to a sports fan. The writings may be all on one disc or partially on each disc.

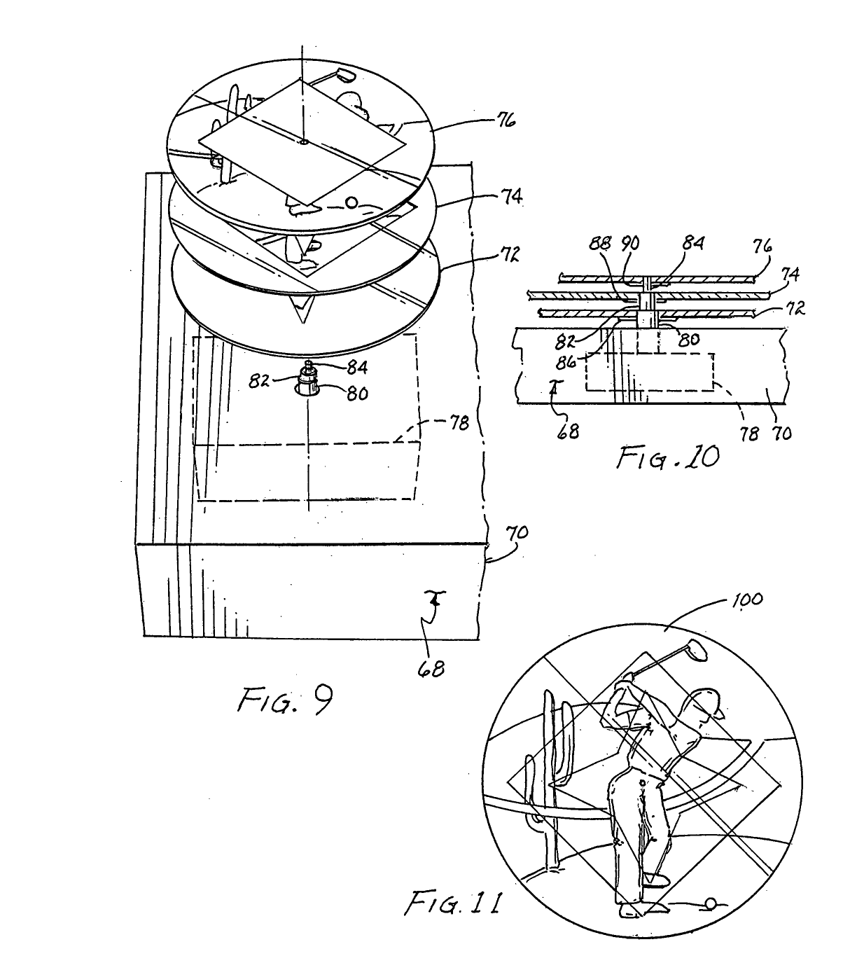

Referring to FIGS. 9 and 10, there is illustrated a more complex composite image generating device 68 including a container 70 supporting three discs 72, 74 and 76, each disc depicting a partial image of the composite image. Motive means, such as an electric motor 78, is secured to container 70 and provides three concentric shafts, each of which rotates at a different rate of rotation. Disc 72 is mounted on shaft 80 which may include a roundel 86 to provide additional support for the disc. Disc 74 is mounted on shaft 82 which may include a roundel 88. Disc 76 is mounted on shaft 84 which may include a roundel 90.

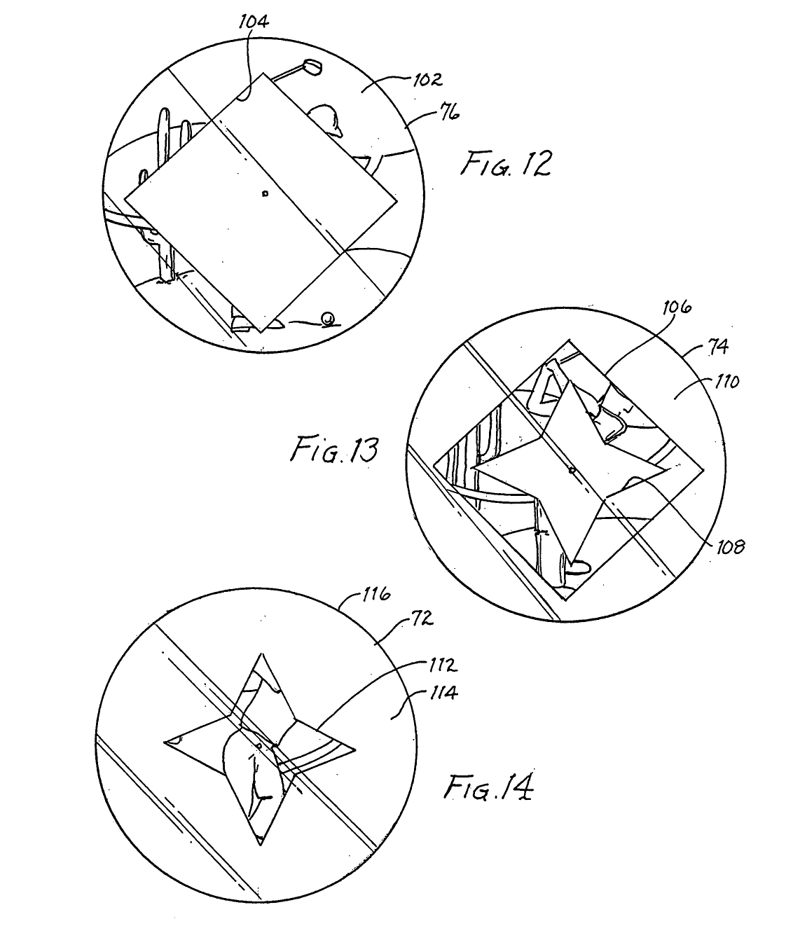

Referring to FIG. 11, there is shown the composite image 100. It is formed of three separate partial images. First partial image 102 is shown in FIG. 12 and it is essentially mounted on and extends adjacent the perimeter of supporting disc 76. Disc 76 is of transparent plastic or other material and the central portion depicted as a square 104 is transparent. Disc 74 shown in FIG. 13 includes a generally square second partial image 106 mounted thereon and having a transparent central star shaped portion 108. Space 110 between second image 106 and the perimeter of disc 74 is transparent. Disc 72 shown in FIG. 14 has mounted thereon a third partial image 112 in the form of a star shape centered in the disc. Space 114 between the third partial image and the perimeter 116 of disc 72 is transparent.

Each of discs 72, 74 and 76 rotates in response to the rate of rotation of respective shafts 80, 82 and 84 extending from container 70 in response to operation of electric motor 78. The rate of rotation of each of these shafts is different. From time to time, the partial images on discs 72, 74 and 76 become aligned to provide the composite image illustrated in FIG. 11.

While the term disc has been employed to describe the base for each of the partial images, it is to be understood that other shapes for supporting the partial images could be employed. Thus, the term disc should be interpreted to include squares, triangles, etc.

I claim:

1. Apparatus for forming a composite image from time to time, said apparatus comprising:
(a) a first partial image of the composite image;
(b) at least a second partial image of the composite image;
(c) motive means for rotating said first partial image about a common axis at a first rate of rotation;
(d) further motive means for rotating said second partial image about the common axis at a second rate of rotation to superimpose said second partial image with said first partial image to form the composite image upon each rotation of said second partial image.

2. The apparatus as set forth in claim 1 including a third partial image of said composite image, yet further motive means for rotating said third partial image about the common axis at a third rate of rotation to superimpose said third partial image with said first and second partial images and form the composite image from time to time.

3. The apparatus as set forth in claim 1 including a motor, said first motive means comprising a first rotating shaft extending from said motor, said second motive means comprising a second rotating shaft extending from said motor concentric with said first shaft.

4. The apparatus as set forth in claim 2 including a motor, said first motive means comprising a first rotating shaft extending from said motor, said second motive means comprising a second rotating shaft extending from said motor concentric with said first shaft, said third motive means comprising a third rotating shaft extending from said motor concentric with said first shaft.

5. The apparatus as set forth in claim 1 wherein each of said first and second partial images is mounted on a first and second disc, respectively.

6. The apparatus as set forth in claim 5 wherein the area of said first disc not containing said first partial image is transparent and wherein the area of said second disc not containing said second partial image is transparent.

7. The apparatus as set forth in claim 3 wherein each of said first and second partial images is mounted on a first and second disc, respectively.

8. The apparatus as set forth in claim 7 including a first roundel mounted on said first shaft for supporting said first disc and a second roundel mounted on said second shaft for supporting said second disc.

9. The apparatus as set forth in claim 8 wherein the area of said first disc not containing said first partial image is transparent and wherein the area of said second disc not containing said second partial image is transparent.

10. The apparatus as set forth in claim 4 wherein each of said first, second and third partial images is mounted on a first, second and third disc, respectively.

11. The apparatus as set forth in claim 10 wherein the area of said first disc not containing said first partial image is transparent, wherein the area of said second disc not containing said second partial image is transparent, and wherein the area of said third disc not containing said third partial image is transparent.

12. A method for forming a composite image from time to time with at least two partial images, said method comprising:
(a) rotating a first partial image about an axis at a first rate of rotation;
(b) further rotating a second partial image about the same axis at a second rate of rotation; an
(c) superimposing the first and second partial images upon each revolution of one of the first or second partial images to form the composite image.

13. The method as set forth in claim 12 wherein said step of rotating includes the step of rotating a first disc depicting the first partial image and wherein said step of further rotating includes the step of further rotating a second disc depicting the second partial image.

14. The method as set forth in claim 13 wherein said steps of rotating and further rotating are carried out by two concentric shafts.

15. The method as set forth in claim 14 including the step of applying motive means for rotating the two concentric shafts.

16. The method as set forth in claim 13 including the step of exposing the second partial image through the area of the first disc not covered by the first partial image.

17. The method as set forth in claim 12 including the step of yet further rotating a third partial image about the same axis at a third rate of rotation and wherein said, step of superimposing includes the step of superimposing the third partial image with the first and second partial images upon each revolution of one of the first, second and third partial images to form the composite image.

18. The method as set forth in claim 17 wherein said step of rotating includes the step of rotating a first, a second and a third disc depicting the first, second and third partial images, respectively.

19. The method as set forth in claim 18 wherein said steps of rotating, further rotating, and yet further rotating are carried out by three concentric shafts, respectively.

20. Apparatus for forming a composite image from time to time, said apparatus comprising:
(a) a first partial image of the composite image mounted on a first disc, said first disc being transparent except at the location of said first partial image;
(b) a second partial image of the composite image mounted on a second disc, said second disc being transparent except at the location of said second partial image;
(c) first and second concentric shafts for supporting said first and second discs, respectively; and
(d) motive means for rotating said first and second shafts at different rates of rotation to superimpose said first and second images to form said composite image from time to time.

21. Apparatus for forming a composite image from time to time, said apparatus comprising:
(a) a first partial image of the composite image mounted on a first disc, said first disc being transparent except at the location of said first partial image;
(b) a second partial image of the composite image mounted on a second disc, said second disc being transparent except at the location of said second partial image;
(c) a fixed support for said first partial image;
(d) a shaft for supporting said second disc, superimposed upon said first disc; and
(e) motive means for rotating said shaft to superimpose said second partial image with said first partial image to form said composite image at each rotation of said second disc.
